(19) United States
(12) Patent Application Publication
(10) Pub. No.: US 2026/0175805 A1
(43) Pub. Date: Jun. 25, 2026

(54) SYSTEM AND METHOD FOR AUTOMATED COCKPIT ADJUSTMENT IN A MOTOR VEHICLE

(71) Applicant: AUDI AG, Ingolstadt (DE)

(72) Inventors: Sebastien AMBROSETTI, Waidhofen (DE); Tahar BOUAZIZ, Ingolstadt (DE); Lutz DIEDERICHS, Kösching (DE); Sebastian FRÖBISCH, Tauberfeld (DE); Marcus HABERER, Pörnbach (DE); Arnold KIEFERLE, Unterschleißheim (DE); Rebekka NEUMANN, Gaimersheim-Lippertshofen (DE); Raphaela SCHEUER, Ingolstadt (DE); Axel SCHINDHELM, Murr (DE); Marcus SCHNEID, Ingolstadt (DE); Torsten SCHWARZ, Gaimersheim (DE); Katrin SEIBEL, Stammham (DE); Sonja WILLEMSEN, Ingolstadt (DE); Toni WÄCHTLER, Schweitenkirchen (DE)

(73) Assignee: AUDI AG, Ingolstadt (DE)

(21) Appl. No.: 18/856,301

(22) PCT Filed: Mar. 7, 2023
(86) PCT No.: PCT/EP2023/055787

§ 371 Date: Oct. 11, 2024

(30) Foreign Application Priority Data
Apr. 12, 2022 (DE) 10 2022 108 977.0

(51) Int. Cl. B60R 16/037; B60K 35/22; B60K 35/53; B60K 35/65; G06F 3/01; G06V 20/59; G06V 40/16; G06V 40/18

(52) U.S. Cl. CPC B60R 16/037; B60K 35/22; B60K 35/53; B60K 35/654; G06F 3/013; G06V 20/59; G06V 40/172; G06V 40/18

(57) ABSTRACT

A system and a method set the cockpit in a motor vehicle automatically. The method includes detecting an eye position of a driver in the motor vehicle using a driver observation camera; determining an optimized cockpit setting on the basis of the detected eye position, with the optimized cockpit setting comprising at least one position setting of a positionally adjustable display screen predetermined on the basis of the eye position; and implementing the optimized cockpit setting, with at least the positionally adjustable display screen being set to the predetermined position setting.

### CROSS REFERENCE TO RELATED APPLICATIONS

This application is a U.S. national stage of International Application No. PCT/EP2023/055787, filed on Mar. 7, 2023. The International Application claims the priority benefit of German Application No. 10 2022 108 977.0 filed on Apr. 12, 2022. Both the International Application PCT/EP2023/055787 and the German Application 10 2022 108 977.0 are incorporated by reference herein in their entirety.

### BACKGROUND

Disclosed herein is a method for setting the cockpit in a motor vehicle automatically, a system designed to implement the method, and a motor vehicle having such a system.

Various control elements are usually used in a motor vehicle to set the cockpit, for example with regards to seat settings, steering wheel settings or mirror settings. A disadvantage of setting these apparatuses by hand is that correctly setting these apparatuses requires much time. Thus, depending on the user's assessment or their experience, correct positioning might be very taxing or not implemented optimally. This may lead to tension or a poor view of the outside or of displays (e.g. electronic visual displays) in the motor vehicle.

DE 10 2008 037 073 A1 has disclosed a method for driving situation-dependent control of a rearview mirror in a motor vehicle. As steps, the method comprises detecting an extended near region around the motor vehicle, measuring the distance to objects situated in the extended near region, calculating a critical object which has, for example, the shortest geometric or temporal distance between an object in the near region and the motor vehicle, and setting the rearview mirror such that the critical object is shifted into the visual field of the driver.

DE 199 33 769 A1 has disclosed a method and an arrangement for individually and automatically setting the function of assemblies of a motor vehicle, especially of assemblies serving driver safety, on the basis of vehicle-specific characteristics.

DE 100 03 220 A1 has disclosed a method and a device for setting the seat and seat-related component assemblies in motor vehicles in driver- or occupant-specific fashion. In order to achieve an improvement in the adjustment to individual ergonomics in this case, provision is made for structure-related data to be ascertained by measuring at least essential points of the overall stature of a driver at least once and for said data to be stored on a storage medium, and for the reading of these data and the inclusion of the dimension data to subsequently lead to ergonomically optimized and automatic setting in the motor vehicle of the settings for the seat contour and/or the settings for the mirrors and steering wheel.

### SUMMARY

An aspect of the present invention is that of simplifying and/or improving the setting of the cockpit in a motor vehicle

An aspect of the invention provides a method for setting the cockpit in a motor vehicle automatically. The method comprises detecting an eye position of a driver in the motor vehicle using a driver observation camera; determining an optimized cockpit setting on the basis of the detected eye position, with the optimized cockpit setting comprising at least one position setting of a positionally adjustable display screen predetermined on the basis of the eye position; and implementing the optimized cockpit setting, with at least the positionally adjustable display screen being set to the predetermined position setting.

In other words, a driver observation camera is initially used to ascertain an eye position or detect eye points of a driver. The driver observation camera may comprise, for example, a stereo camera, a time-of-flight camera and/or a plurality of lenses or focal points in order to determine the eye position in the passenger compartment in three dimensions. In particular, a driver observation camera recording can be analyzed by an image analysis algorithm in order to recognize the eyes in the recording and hence determine the eye position. A viewing direction may also be ascertained.

A cockpit setting that is optimized for the eye position can subsequently be determined, especially by a controller, on the basis of the ascertained eye position, the optimized cockpit setting including at least one position setting of a positionally adjustable display screen predetermined in this respect. The positionally adjustable display screen can be a driver information display (DID), a center information display (CID) and/or a head-up display (HUD), wherein the display screen can be brought into different positions by way of suitable drive means (i.e., electric motors). For example, a center information display can be adjusted in terms of its height direction, lateral direction and/or longitudinal direction by way of electric motors. The respective position setting for the display screen can be predetermined for the respective eye position, especially with respect to ergonomics.

Determining the optimized cockpit setting can be followed by controlling the positionally adjustable display screen, for example by way of the controller, such that said display screen is moved into the predetermined position setting.

By way of example embodiment, further parameters can also be taken into account in the context of setting the cockpit automatically, for example a driver's height, a steering wheel setting and/or a seat setting, in order to implement the optimal position of the display screen and/or further apparatuses in the cockpit. By way of example embodiment, automated setting of the cockpit can also be followed by a manual readjustment of the display screen settings.

Aspects of the invention give rise to the advantage that the cockpit setting, in particular the setting of the positionally adjustable display screen, can be implemented quickly and automatically, in particular with ergonomic aspects being taken into account

Aspects of the invention also comprise example embodiments which afford additional advantages.

One example embodiment provides for the positionally adjustable display screen to be set at least in terms of a height direction and/or longitudinal direction of the motor vehicle. That is to say the display screen can be moved at least in a z-direction of the motor vehicle and/or in an x-direction of the motor vehicle in order to ensure an optimal view using the detected eye position as a starting point. In an alternative to that or in addition, the display screen can also be adjusted in a lateral direction (y-direction) and/or be tilted in one or more directions. For example, the display screen can be moved by electric motors in this context

A further example embodiment provides for the optimized cockpit setting to be additionally implemented on the basis of a specified driver's height. The driver's height can be stored for a driver of the motor vehicle, wherein, in addition to an optimized viewing angle of the display screen, it is also possible to make inferences regarding the reachability of input elements on the display screen and optimize these using the driver's height. Moreover, further cockpit settings can also be implemented on the basis of the specified driver's height

By way of example embodiment, provision is made for a steering wheel position and/or seat position to be additionally set on the basis of the detected eye position and the driver's height. Thus, in addition to the display screen, the steering wheel can also be adjusted in the height direction and/or longitudinal direction of the motor vehicle, for example in order to obtain good reachability for the driver and/or in order to optimize a view of the driver information display/instrument cluster on the basis of the eye position. As an alternative to that or in addition, the seat position, i.e., the height direction and/or longitudinal direction and/or seatback inclination, can be set on the basis of specified optimized cockpit settings. This can further improve the ergonomics by virtue of the steering wheel and/or the seat being set automatically.

In a further example embodiment, provision is made for an inside mirror and/or outside mirrors to be set on the basis of the detected eye position. Byway of example embodiment, provision can also be made for virtual outside mirrors, the position of which is adjusted on the basis of the detected eye position. This embodiment gives rise to the advantage that ergonomics and also safety can be improved since the optimized setting of the mirrors can be implemented automatically.

A further example embodiment provides for a graphical user interface of the display screen and/or of at least one further screen in the motor vehicle to be set on the basis of the detected eye position. This means that the graphical user interface which can be displayed on the respective screen is also modified in terms of its position and display on the screen so as to be optimized for the detected eye position. This can adapt the visibility of the graphical user interface and/or a controllability of the graphical user interface to the detected eye position.

A further example embodiment provides for individualized cockpit settings to be stored in a user profile, with facial recognition being implemented by the driver observation camera and the individualized cockpit settings being retrieved on the basis of the facial recognition. Individualized cockpit settings can be manually undertaken changes which are undertaken after the automated and optimized cockpit settings have been set. These can be stored in a respective user profile which is able to be linked to a user's face. The driver observation camera can retrieve the user profile when this face is recognized, and thus offer and/or automatically implement the individualized cockpit setting. This can save time since individualized settings can be obtained quickly and easily.

Byway of example embodiment, provision is made for the detected eye position to be used to check whether the individualized cockpit setting deviates from the optimized cockpit setting, with a notification being output should the individualized cockpit setting deviate from the optimized cockpit setting. That is to say the detected eye position can recognize whether the individualized cockpit setting deviates from the ergonomically optimized settings, and, if so, this can be brought to the user's attention, in particular by way of a notification offering to undertake an optimization. The latter can then be implemented following a confirmation.

A further aspect of the invention relates to a system for setting the cockpit automatically, having a driver observation camera designed to detect an eye position and having a controller designed to determine an optimized cockpit setting on the basis of the detected eye position, said optimized cockpit setting comprising at least one position setting of a positionally adjustable display screen predetermined on the basis of the eye position. Moreover, the controller is designed to create a control signal for implementing the optimized cockpit setting and control at least the positionally adjustable display screen therewith to set the latter to the predetermined position setting. The same advantages and variation possibilities as in the case of the method arise.

According to an aspect of the invention, a motor vehicle having such a system is also provided. The motor vehicle according to the invention is embodied, for example, in the form of a motorized vehicle, in particular as a passenger car or truck, or as a minibus or motorcycle.

An aspect of the invention also includes the control device for the motor vehicle. The control device may comprise a data processing device or a processor device configured to carry out an example embodiment of the method according to the invention. For this purpose, the processor device may comprise at least one microprocessor and/or at least one microcontroller and/or at least one FPGA (field programmable gate array) and/or at least one DSP (digital signal processor). Furthermore, the processor device may comprise program code configured to carry out the example embodiment of the method according to the invention upon execution by the processor device. The program code may be stored in a data memory of the processor device.

An aspect of the invention also includes developments of the system according to the invention, which have features as have already been described in connection with the developments of the method according to the invention. For this reason, the corresponding developments of the system according to the invention will not be described again here.

As a further solution, aspects of the invention also comprise a computer-readable storage medium comprising commands which, when executed by a computer or a computer network, prompt the latter to carry out an example embodiment of the method according to the invention. For example, the storage medium can be configured, at least in part, as a non-transitory data memory (e.g. as a flash memory and/or as an SSD-solid-state drive) and/or, at least in part, as a transitory data memory (e.g. as a RAM-random access memory). The computer or computer network can provide a processor circuit having at least one microprocessor. The commands can be provided as a binary code or assembler and/or as source code in a programming language (e.g. C).

The invention also comprises the combinations of the features of the described example embodiments. The invention thus also comprises implementations, each having a combination of the features of a plurality of the embodiments described, provided that the example embodiments were not described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a schematically illustrated motor vehicle according to an exemplary embodiment;

FIG. 2 shows a schematically illustrated cockpit view according to an exemplary embodiment.

### DETAILED DESCRIPTION

Reference will now be made in detail to the preferred embodiments, examples of which are illustrated in the accompanying drawings, wherein like reference numerals refer to like elements throughout.

The exemplary embodiments discussed below are example embodiments of the invention. In the exemplary embodiments, the described components of the embodiments each represent individual features of the invention that should be considered independently of one another and also develop the invention in each case independently of one another. The disclosure is therefore also intended to comprise combinations of the features of the embodiments other than those illustrated. Furthermore, the described embodiments may also be supplemented by further features of the invention that have already been described.

In the figures, identical reference signs each denote elements of identical function.

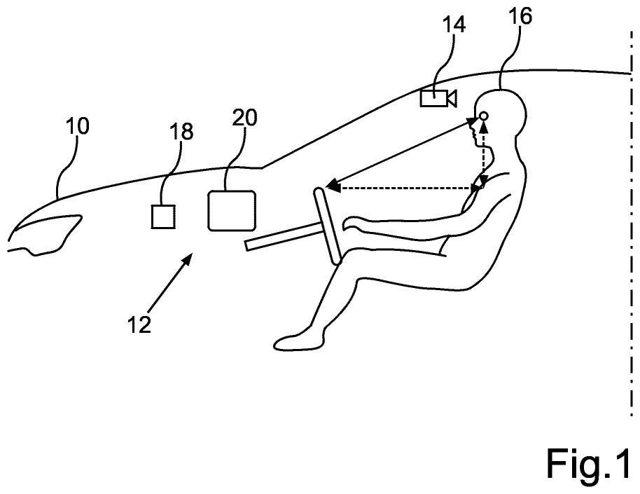

FIG. 1 depicts a motor vehicle 10 having a system 12 for setting the cockpit automatically according to an exemplary embodiment. The system 12 comprises a driver observation camera 14 which is designed to ascertain an eye position of a driver 16 in a passenger compartment of the motor vehicle 10. To this end, the driver observation camera 14 can be directed at the driver 16 and can determine the eye position in a depth plane and, in addition thereto, in the plane of the surface, for example by setting focal points. As an alternative to that or in addition, a stereo camera allowing depth information to be obtained can also be provided as driver observation camera.

The detected eye position can be evaluated by a controller 18 of the motor vehicle 10, wherein an optimized cockpit setting is determined on the basis of the eye position and for example with the aid of a specified driver's height, the optimized cockpit setting allowing various positionally adjustable apparatuses within the motor vehicle 10 to be optimized, for example with respect to ergonomics. In particular, at least one predetermined position setting of a positionally adjustable display screen 20 can be ascertained for the optimized cockpit setting and on the basis of the eye position. In other words, the ascertained eye position can be used to ascertain the position setting for the display screen 20 allowing the best and most ergonomic view of the said display screen 20, wherein this may be predetermined for each eye position. For example, the display screen 20 can be a driver information display, a center information display and/or a head-up display.

In this exemplary embodiment, the optimal viewing angle for the display screen 20 can be ascertained on the basis of the eye position and by way of example embodiment with the aid of the known driver's height and a steering wheel setting. The controller 18 which receives and evaluates the recording from the driver observation camera 14 can then control positioning means (not shown) of the display screen 20, for example electric motors, on the basis of the eye position in order to set the display screen 20 to the optimized position setting.

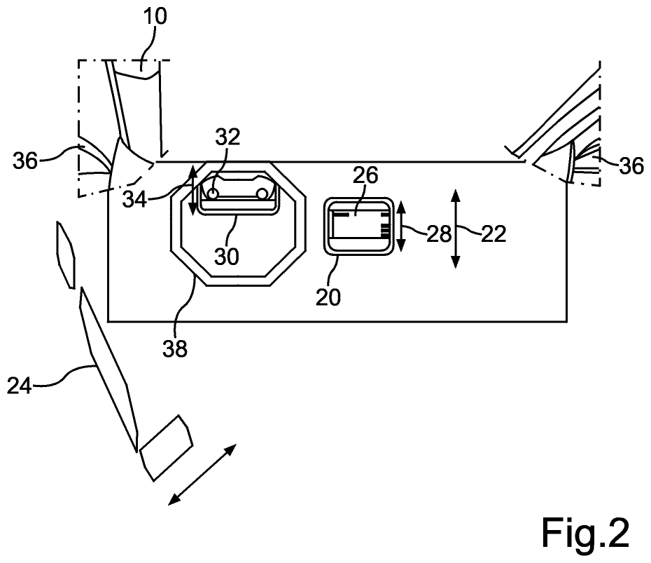

In addition to the positionally adjustable display screen 20, further apparatuses in the cockpit can also be set on the basis of at least the detected eye position; for example, this is depicted in FIG. 2.

FIG. 2 shows a schematic cockpit view of an instrument panel of the motor vehicle 10, with the respective double-headed arrows indicating adjustment travels of respective cockpit apparatuses. As already explained in the preceding figure, the display screen 20, depicted as a center information display 20 in this figure, can for example be adjusted in terms of its height direction along an adjustment travel 22. As an alternative to that or in addition, the center information display 20 can also be adjusted in the vehicle longitudinal direction or be adjusted about an axis, for example in the direction of a driver's seat 24. Particularly, a graphical user interface 26 which can be displayed on the center information display 20 can also be displaced within the center information display 20 or can be increased or reduced in size on the basis of the detected eye position in order to allow an optimized view and/or an optimized reachability of the graphical user interface 26. For example, the graphical user interface 26 can be displaced on the display screen 20 along the adjustment travel 28.

In the same way, a driver information display 30 and a graphical user interface 32 displayed thereon can be adjusted along an adjustment travel 34 of the graphical user interface 32 of the driver information display 30. Moreover, external mirrors 36 and a position setting for the driver's seat 24 and/or the steering wheel 38 can be set on the basis of the detected eye position.

In addition to setting the cockpit automatically, there can also be an individualized cockpit setting for the aforementioned apparatuses on a manual basis, with the individualized cockpit settings being able to be stored in a user profile. In this context, a face can be assigned to the user profile, by, for example, the driver observation camera 14, wherein the driver observation camera 14 can retrieve and offer or implement the individualized cockpit setting upon recognition of the face using facial recognition. Particularly, provision is made for the individualized cockpit setting to be able to be analyzed retrospectively on the basis of the detected eye position, wherein a notification regarding an optimization of the cockpit setting can be output should the detected eye position not be optimized for the cockpit setting.

In a further exemplary aspect, provision is made for the motor vehicle 10 to be equipped with one or more displays 20, 30. In front of the driver 16, a driver observation camera 14 detects the eye point of the driver 16, for example in a manner dependent on a driver's height and a seat position. By way of example embodiment, the driver observation camera 14 comprises a plurality of lenses or focal points for an even more accurate detection. Moreover, the driver observation camera 14 can also detect significant changes of a viewing angle of the driver 16, for example in the longitudinal axis.

Various components of the cockpit, for example the display screens 20, 30, outside mirrors 36, a driver's seat 24 and/or a steering wheel 38, are linked to the driver observation camera 14 by way of a controller 18, wherein the cockpit settings can also be personalized by way of the controller 18.

Furthermore, the motor vehicle 10 may comprise a graphical user interface 26, 30 with a responsive design, for example in the driver information display 30, in the center information display 20 and/or in a head-up display, wherein a scalability of the graphical user interface on the respective display screen can be set on the basis of the eye position.

Overall, the examples show how the invention allows implementation of an automated and personalized cockpit setting on the basis of an eye point detection.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1.-10. (canceled)

11. A method for setting a cockpit in a motor vehicle automatically, the method comprising:
detecting, by a driver observation camera, an eye position of a driver in the motor vehicle;
determining an optimized cockpit setting on the basis of the detected eye position, with the optimized cockpit setting comprising at least one position setting of a positionally adjustable display screen predetermined on the basis of the eye position;
implementing the optimized cockpit setting, with at least the positionally adjustable display screen being set to the predetermined position setting;
setting a graphical user interface of the display screen and/or of at least one further screen in the motor vehicle on the basis of the detected eye position;
modifying the graphical user interface in terms of its position and display on the display screen.

12. The method as claimed in claim 11, further comprising setting the positionally adjustable display screen at least in terms of a height direction and/or longitudinal direction of the motor vehicle.

13. The method as claimed in claim 11, wherein the optimized cockpit setting is additionally implemented on the basis of a specified driver's height.

14. The method as claimed in claim 12, wherein the optimized cockpit setting is additionally implemented on the basis of a specified driver's height.

15. The method as claimed in claim 13, further comprising setting a steering wheel position and/or seat position on the basis of the detected eye position and the driver's height.

16. The method as claimed in claim 14, further comprising setting a steering wheel position and/or seat position on the basis of the detected eye position and the driver's height.

17. The method as claimed in claim 11, further comprising setting an inside mirror and/or outside mirrors on the basis of the detected eye position.

18. The method as claimed in claim 12, further comprising setting an inside mirror and/or outside mirrors on the basis of the detected eye position.

19. The method as claimed in claim 13, further comprising setting an inside mirror and/or outside mirrors on the basis of the detected eye position.

20. The method as claimed in claim 14, further comprising setting an inside mirror and/or outside mirrors on the basis of the detected eye position.

21. The method as claimed in claim 15, further comprising setting an inside mirror and/or outside mirrors on the basis of the detected eye position.

22. The method as claimed in claim 16, further comprising setting an inside mirror and/or outside mirrors on the basis of the detected eye position.

23. The method as claimed in claim 11, further comprising:
storing individualized cockpit settings in a user profile,
implementing, by the driver observation camera, facial recognition, and
retrieving the individualized cockpit settings on the basis of the facial recognition.

24. The method as claimed in claim 12, further comprising:
storing individualized cockpit settings in a user profile,
implementing, by the driver observation camera, facial recognition, and
retrieving the individualized cockpit settings on the basis of the facial recognition.

25. The method as claimed in claim 13, further comprising:
storing individualized cockpit settings in a user profile,
implementing, by the driver observation camera, facial recognition, and
retrieving the individualized cockpit settings on the basis of the facial recognition.

26. The method as claimed in claim 14, further comprising:
storing individualized cockpit settings in a user profile,
implementing, by the driver observation camera, facial recognition, and
retrieving the individualized cockpit settings on the basis of the facial recognition.

27. The method as claimed in claim 23, further comprising:
checking, based on the detected eye position, whether the individualized cockpit setting deviates from the optimized cockpit setting, and
outputting a notification when the individualized cockpit setting deviates from the optimized cockpit setting.

28. The method as claimed in claim 24, further comprising:
checking, based on the detected eye position, whether the individualized cockpit setting deviates from the optimized cockpit setting, and
outputting a notification when the individualized cockpit setting deviates from the optimized cockpit setting.

29. A system for setting a cockpit automatically, comprising:
a driver observation camera to detect an eye position; and
a controller to determine an optimized cockpit setting on the basis of the detected eye position, said optimized cockpit setting comprising at least one position setting of a positionally adjustable display screen predetermined on the basis of the eye position, and to create a control signal for implementing the optimized cockpit setting, by which at least the positionally adjustable display screen is set to the predetermined position setting, wherein
the control signal additionally setting a graphical user interface of the display screen on the basis of the detected eye position, the graphical user interface being modified in terms of its position and display on the display screen.

30. A motor vehicle having a system as claimed in claim 29.
